(19) United States
(12) Patent Application Publication
(10) Pub. No.: US 2025/0373989 A1
(43) Pub. Date: Dec. 4, 2025

(54) In-Line Focused Acoustic Energy Transducer and Methods of Use

(71) Applicant: Product Systems Incorporated, Campbell, CA (US)

(72) Inventors: Mark J. Beck, Los Gatos, CA (US); Eric G. Liebscher, San Jose, CA (US); Alexander Y. Schweizer, Sunnyvale, CA (US)

(21) Appl. No.: 19/220,444

(22) Filed: May 28, 2025

Related U.S. Application Data
(60) Provisional application No. 63/653,160, filed on May 29, 2024.

(51) Int. Cl. H04R 17/10; B24B 1/00

(52) U.S. Cl. CPC H04R 17/10; B24B 1/002; H04R 2217/01

(57) ABSTRACT

An acoustic energy tool comprising a crystal for generating acoustic energy when a volage is applied to the crystal, and a resonator. The resonator has a solid outer structure with the crystal being attached to the solid outer structure, with the resonator being comprised of a material that transmits the acoustic energy through the resonator. The tool includes a curved surface that focuses the acoustic energy being transmitted through the resonator and a fluid passageway that extends through the resonator for allowing a fluid to flow through the resonator. The acoustic energy being focused by the curved surface is concentrated in the fluid passageway so that it causes cavitation of the fluid in at least part of the fluid passageway. The cavitation of the fluid is used to break up clumps that form in the fluid or to generate reactive oxygen species.

### RELATED APPLICATIONS

This application claims the benefit of U.S. provisional application 63/653,160, filed May 29, 2024, which is incorporated herein by reference.

### TECHNICAL FIELD

This invention relates to an in-line acoustic transducer that delivers focused acoustic energy into fluids, and more particularly to transducers and methods that deliver focused acoustic energy into slurries, water and other chemicals used in chemical mechanical polishing processes during the manufacturing of substrates such as semiconductor or optical devices, as well as other processes for planarization.

### BACKGROUND OF THE INVENTION

Integrated circuits (ICs) are an essential part of our economy. Manufacturing an advanced IC can take as many as a thousand processing steps over a fifteen-week period and may require as many as five hundred different tools. The manufacturing process is performed in special clean rooms and uses very clean water and chemicals.

During the IC manufacturing process (and in other manufacturing processes), it is often necessary to smooth down the surface of the substrate being worked on. Typically, a process known as chemical mechanical polishing (CMP) is used for this purpose. In a CMP process, a process fluid (e.g., a chemical slurry) is applied to a rotating polishing pad and the circular wafer (or other substrate) is rotated and pressed against the polishing pad to planarize the surface of the wafer or substrate. The process fluid is usually an aqueous solution containing suspended (colloidal) particles.

The suspended particles in the process fluid are very small and provide a fine abrasive medium that helps remove the film from the substrate being cleaned. Typical process fluids comprise water, hydrogen peroxide, some proprietary chemicals, and the suspended particles. The suspended particles are commonly silicon dioxide (SiO₂) but can be other materials such as aluminum dioxide (AlO₂) or cerium dioxide (CeO₂). Some of the substrates that are cleaned in this manner include semiconductor wafers and glass and ceramic substrates, as well as substrates comprised of other materials.

In the CMP process, the process fluid is pumped from a source through a supply line to the polishing pad that uses the “slurry” to perform the grinding/polishing/removal process on the semiconductor wafer. The quality of the finished surface can depend on how well the particles stay suspended in the process fluid. A problem that sometimes arises is that the particles attract each other and form large clusters or clumps. These clusters may plug filters in the supply line and can cause scratches on the surface being polished if they get through the filters. One way to improve the CMP process is to eliminate or minimize the clusters that may form in the process fluid. Another way to improve the CMP process is to enhance the process fluid with energetic reactive oxygen species that increase the effectiveness of the process fluid in cleaning the surface of the substrate.

### SUMMARY OF THE INVENTION

Briefly, the present invention comprises a tool for delivering focused acoustic energy into a passageway through which a process fluid is flowing. The tool comprises a resonator having a solid outer structure and a fluid passageway running through the center of the resonator. A process fluid can flow through the fluid passageway. A crystal for generating acoustic energy is attached to the solid outer structure. The resonator is comprised of a material that transmits the acoustic energy through the resonator and includes a curved surface that focuses the acoustic energy. The acoustic energy is focused by a curved surface in the tool. The focused acoustic energy is concentrated in the fluid passageway and causes cavitation in the fluid in at least part of the fluid passageway.

The cavitation in the fluid is used in two ways. First, the energy released during cavitation can be used to break up clumps of particles that form in the process fluid. Second, the energy released during cavitation can be used to generate reactive oxygen species (ROS) in the process fluid which increases the effectiveness of the process fluid in the function it is being used for, such as in a cleaning or planarization (CMP) process.

### BRIEF DESCRIPTION OF THE DRAWINGS

FIG. 1 is an isometric view of the in-line focused acoustic energy tool according to the present invention.

FIG. 2 is a cross-sectional side view of the in-line focused acoustic energy tool according to the present invention.

FIG. 3 is a schematic cross-sectional view of the in-line focused acoustic energy tool according to the present invention.

FIG. 4 is a schematic cross-sectional side view of the in-line focused acoustic energy tool according to the present invention.

FIG. 5 is an isometric view of the in-line focused acoustic energy tool that uses flat crystals according to the present invention.

FIG. 6 is a schematic cross-sectional view of the flat crystal focused acoustic energy tool according to the present invention.

FIG. 7 is an isometric view of the flat crystal focused acoustic energy tool with a protective housing over the crystals according to the present invention.

### DETAILED DESCRIPTION

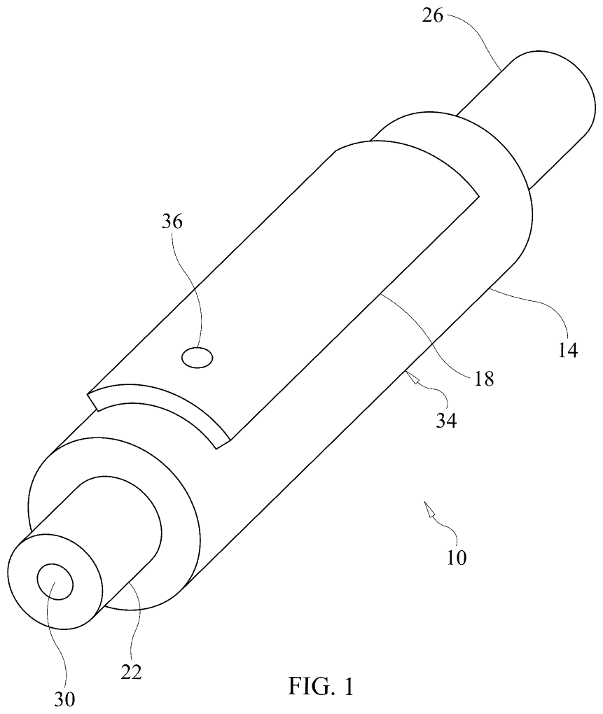

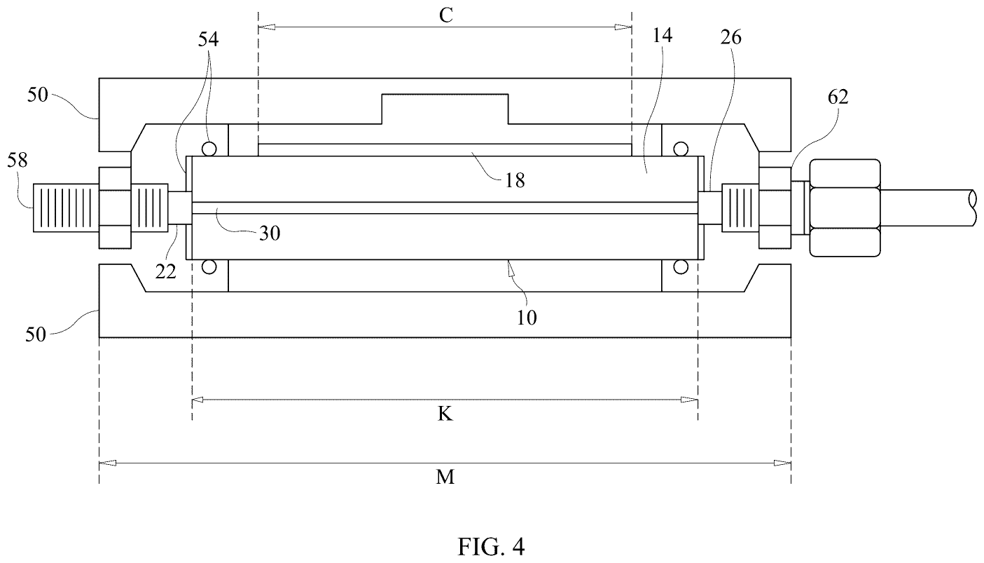

FIG. 1 illustrates an in-line focused acoustic energy tool 10 used for delivering focused acoustic energy into a process fluid that flows through the tool 10. In a preferred embodiment, the tool 10 comprises a resonator 14, a crystal 18, a first end member 22, a second end member 26, and a fluid passageway 30. The combination of the crystal 18 and the resonator 14 forms a transducer 34 that transmits acoustic energy. The resonator 14 has a shape that focuses the acoustic energy in or near the passageway 30. Process fluid from a fluid source (not shown) flows through fluid passageway 30. An electrical contact 36 provides an electrical connection between the crystal 18 and an RF generator (not shown). In preferred embodiments, the ends of the members 22 and 26 are attached to threaded members (as shown in FIG. 4) that allow the tool 10 to be inserted into a fluid line connected to the fluid source. Preferably, the members 22 and 26 are just machined down extensions of the resonator 14 and not separate pieces of material.

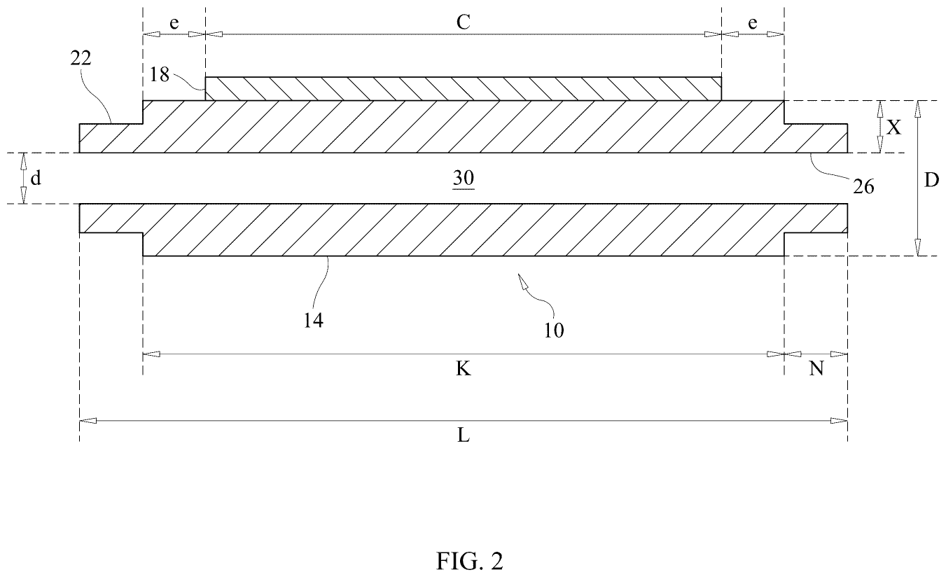

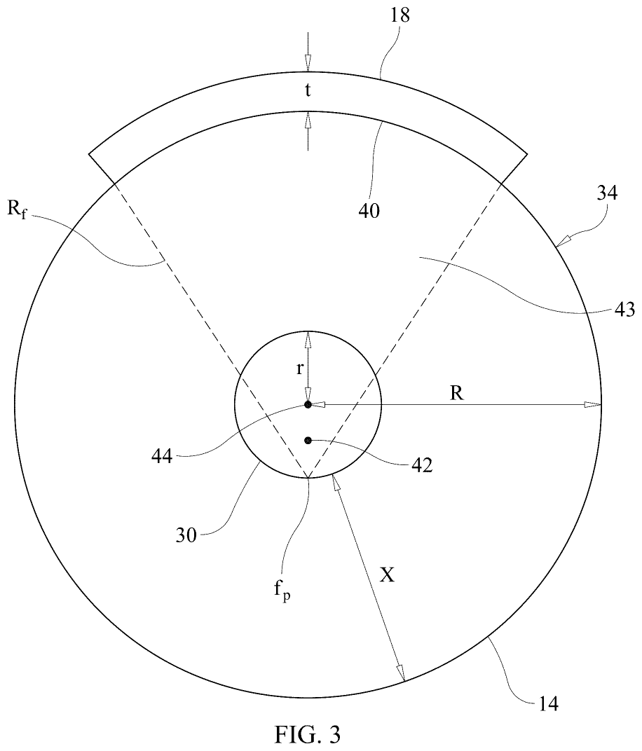

FIG. 2 illustrates a preferred embodiment of the invention showing some of the dimensions of the tool 10 and illustrating that the fluid passageway 30 extends through the tool 10. The fluid passageway 30 is a hollow cavity that allows a fluid (preferably a liquid) to flow through the tool 10. In a preferred embodiment, the fluid passageway 30 is cylindrical in shape and the passageway 30 has a circular cross section, but the passageway 30 could have other shapes, such as an elliptical cylinder or a rectangle. Acoustic energy moving through the resonator 14 is focused in or near the fluid passageway 30, as is explained with respect to FIG. 3. The tool 10 has length L that extends from the end of the first end member 22 to the end of the second end member 26. The first end member 22 and the second end member 26 each have a length N, while the resonator 14 has a length K. The crystal 18 has a length C and is preferably positioned a distance “e” from each end of the resonator 14. The tool 10 has a width “D” (i.e., an outer diameter or OD) and the fluid passageway 30 has a diameter “d” (i.e., an inner diameter or ID) and the resonator 14 has a thickness “X” between the outside of the resonator 14 to the perimeter of the fluid passageway 30. The crystal 18 has a thickness “t” (shown in FIG. 3).

FIG. 3 illustrates how the transducer 34 focuses acoustic energy from the crystal 18 in the fluid passageway 30. The curvature of the crystal 18 acts like a cylindrical lens 40 (represented by the curved edge of the resonator underneath the crystal 18) to focus acoustic energy emitted by the crystal 18 at a focal point (fp). The term “focused” (or “concentrated”) acoustic energy means that the power (preferably measured as watt density) of the focused acoustic energy is greater than the power (watt density) applied to the crystal. The focusing of the acoustic energy (and the increase in power in the acoustic energy) is caused by the curvature of the crystal 18 represented by the lens 40. The focused acoustic energy is transmitted or conducted to the focal point (fp) by the resonator 14.

The focal point is located at a distance Rf (also known as the focal length) from the edge of the lens 40. Preferably, the transducer 34 (i.e. the combination of the resonator 14 and crystal 18) is designed so that the focal point is located inside the fluid passageway 30. For example, for some designs, the focal point could be located at the point 42 inside the fluid passageway 30. However, based on the design of the resonator 14, the focal point could be outside of the passageway 30. The focused acoustic energy moving through the resonator 14 is limited to the pie-shaped wedge 43 underneath the crystal 18. The wedge 43 extends laterally along the length of the C of the crystal 18, so the focused acoustic energy (and the focal point) extends along a region having the length C (shown in FIG. 2) inside or near the fluid passageway 30.

Several parameters that affect the location of the focal point include the design frequency (Fo) of the crystal 18, the material from which the resonator 14 is made, the radius of the resonator 14 (labeled R in FIG. 3), the velocity of sound in the resonator designated as V_{R}, in units of millimeters/microsecond (mm/μs), and the velocity of sound in the fluid (designated as V_{F}, units mm/μs). The fluid passageway 30 has a radius “r” measured from the center 44 of the passageway 30 (“r” is one-half the diameter “d” shown in FIG. 2, also referred to as one-half the inner diameter “ID”). The thickness X of the resonator 14 is the radius (R) of the resonator 14 minus the radius “r” of the fluid passageway 30 (the radius R is measured from the center 44 to the edge of the resonator 14 and is also referred to as one-half the outer diameter “OD” of the resonator 14). The thickness X is also shown in FIG. 2. In a preferred embodiment, Fo=925 kHz. This frequency is chosen for practical reasons such as the availability of piezoelectric crystals that operate at this frequency.

The formula for calculating the position of the focal point for the transducer 34 is: fp=R/(n−1)/n, where fp is the focal point; R is the radius of the resonator 14; and n is V_{R}/V_{F}, where V_{R} is the velocity of sound in the resonator and V_{F} velocity of sound in the fluid. Using this equation, the dimensions and composition of the resonator 14 can be selected so that the focal point is positioned in (or near) the fluid passageway 30. Table 1 below gives some values and dimensions for a representative design of the transducer 34, and the resulting position of the focal point (i.e., the focal length) relative to the lens 40.

TABLE 1

| | | | | | | λ (mm) | | |
|---|---|---|---|---|---|---|---|---|
| | V_{R} | V_{F} | n | R (mm) | r (mm) | @ 925 | | |
| material | (mm/μs) | (mm/μs) | (=V_{R}/V_{F}) | ½ OD | ½ ID | kHz | (n − 1)/n | fp (mm) |
| 316 SS | 5.9 | — | 3.9 | 22.5 | 3.75 | 6.35 | .75 | 30.0 |
| sapphire | 11.1 | — | 7.4 | 9.0 | 3.0 | 12.0 | .86 | 10.46 |
| water | — | 1.5 | | | | 1.62 | | |

From Table 1, it can be seen that for an in-line focused acoustic energy tool 10 comprised of sapphire (with the listed parameters), the focal point is 10.46 mm away from the lens 40. This puts the focal point inside of the fluid passageway 30 because the passageway 30 extends 6 to 12 mm (i.e., R−r to R+r) from the lens 40 and the focal point is 10.46 mm away from the lens 40. For a tool 10 comprised of stainless steel (with the listed parameters), the focal point is slightly outside of the fluid passageway 30 because the passageway 30 extends 18.75 to 26.25 mm from the lens 40 and the focal point is 30.0 mm away from the lens 40.

In order for acoustic energy to pass through the resonator 14 with the least amount of attenuation, the resonator 14 should have a thickness X that is a half-multiple of the wavelength of the acoustic energy. The wavelength (2) of sound in the resonator 14 is given by V_{R}/Fo (where V_{R} and Fo are defined above). For a sapphire resonator and a design frequency of 925 kHz, 2=11.1 mm/μs/0.925 kHz=12 mm. So, for 925 kHz sound to pass through a sapphire resonator with minimal attenuation, the resonator should have a thickness of one-half multiples of 12 mm. In FIG. 3, X is preferably 6 millimeters (i.e., “R” minus “r”=9 mm minus 3 mm=6 mm).

FIG. 4 is a schematic cross-sectional view illustrating the in-line focused acoustic energy tool 10 enclosed in a housing 50. The housing 50 encloses the tool 10 and protects it from contamination, such as liquid contamination. The gasket seals 54 are used because bonding to sapphire is not easy. Use of the gasket seals 54 allows the housing 50 to be sealed to the sapphire resonator by clamping the housing 50 together and squeezing the gaskets to the ends of the resonator 14 to form a liquid-tight seal. In a preferred embodiment, the first end member 22 is connected to a one-eighth inch NPT outlet 58 (or by some other connection method) that allows the tool 10 to be connected to a processing tool, such as a CMP system. The process fluid flows through the to the fluid passageway 30 and out the outlet 58. In a preferred embodiment, the second end member 26 is connected to a one-eighth inch NPT by one-quarter inch tube inlet 62 that allows the tool 10 to be connected to a source supply for the process fluid. The resonator 14 has the length K and the crystal 18 has the length C, both of which are also shown in FIG. 2. The housing 50 has a length M.

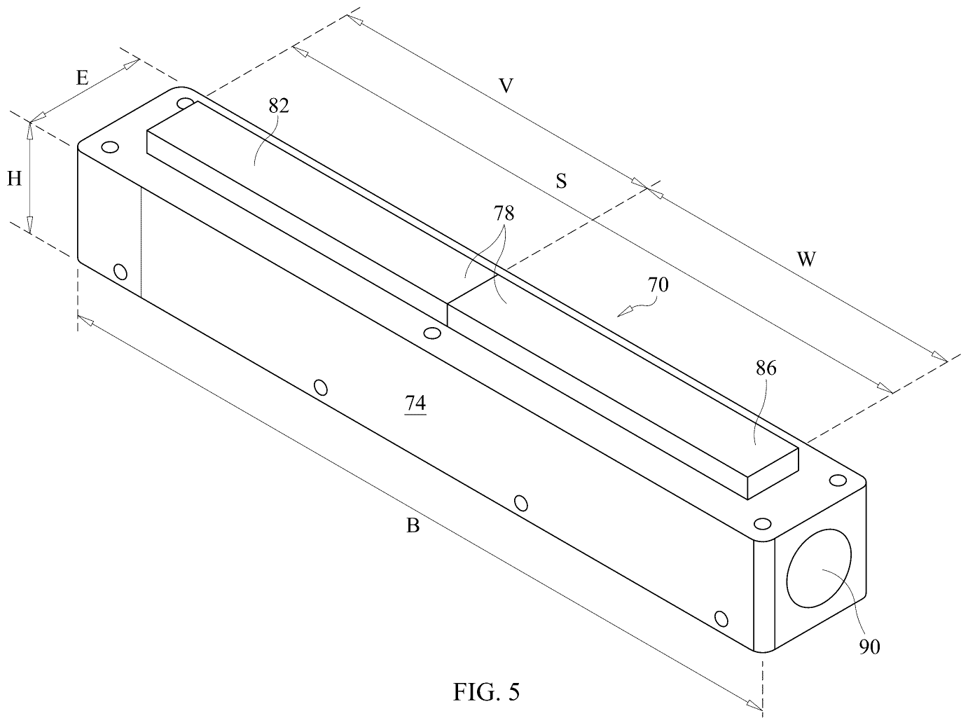

Preferably, the crystal 18 is attached to the resonator 14 using an adhesive material such as indium or an epoxy. The crystal 18 should fit tightly against the resonator 14. Preferably, the crystal 18 comprises a PZT type crystal (lead zirconate titanate crystal), such as a man-made crystal that vibrates at a designed frequency, but other piezoelectric materials can be used. In a preferred embodiment, this is a 90-degree PZT crystal operating at 925 kHZ. A 90-degree PZT crystal refers to how far around the cylindrical resonator 14 the crystal reaches (i.e., a 90-degree crystal reaches around 25% of the way around the circumference of the resonator). Another way of stating this is that the arc of a 90-degree crystal subtends an angle of ninety degrees. A 360-degree crystal would reach completely around the circumference of the resonator. Other sizes of crystals can be used, such as a 110-degree crystal or some other size, and other types of piezoelectric materials can be used for the crystal 18. Furthermore, flat crystals can be used as is described below with respect to FIGS. 5-7.

In a preferred embodiment, the resonator 14 is comprised of sapphire, but other materials such as stainless steel (e.g. 316 stainless steel), silicon carbide, silicon nitride, vitreous carbon, quartz, ceramic materials, and diamond-like carbon (DLC) coated materials can be used. A general consideration for the resonator material is that it is compatible with the fluid being used (i.e., it doesn't react with the fluid). This consideration favors sapphire because of its inertness.

In FIG. 1, an electrical contact 36 provides an electrical connection between the crystal 18 and an RF generator/power source (not shown). The RF power source provides AC power to the crystal 18, preferably in the frequency range of 300 kHz to 5 MHz. Suitable RF power supplies are commercially available, such as an AB broadband amplifier, but other types such as a DE broadband amplifier can be used. In a preferred embodiment, the RF power supply operates at 925 kHz, but other frequencies can be used, such as frequencies in the 300 kHz to 6 MHz range. The watt density (i.e., power) applied to the crystal should be determined by experimentation, including the composition of the process fluid being used, with the goal being to cause an appropriate amount of cavitation in the process fluid. For example, in the tool 10 described above with a 90-degree PZT crystal, the power of the focused acoustic energy is about 56 times greater than the power applied to the crystal. So, if power of 1 W/cm² is inputted into the crystal 18, the watt density (power) of the acoustic energy at the focal point will be about 56 W/cm². If the power of the focused acoustic energy causes too much cavitation, or damages the fluid properties, the initial power applied to the crystal 18 can be reduced. In a preferred embodiment, a watt density (power) of up to 50 W/cm² at the focal point can be used.

In operation, the in-line focused acoustic energy tool 10 can be used in a number of ways. The general advantage of the tool 10 is that its design can deliver highly energetic acoustic energy into the process fluid in the passageway 30. Without limiting the ways the tool 10 can be utilized, two specific processes are described below. In the first process, the tool 10 is used to prevent or minimize clumps from forming in a process fluid used in a chemical mechanical polishing process during the manufacturing of semiconductor devices. In the second process, the tool 10 is used to generate reactive oxygen species in a process fluid used in a chemical mechanical polishing process during the manufacturing of semiconductor devices.

The anti-clumping use of the tool 10 is described first. A standard manufacturing process for the removal of films on substrates utilizes a process fluid containing suspended particles. The suspended particles in the process fluid are very small and provide a fine abrasive medium that helps remove the film from the substrate being processed. Typical process fluids comprise water, hydrogen peroxide, some proprietary chemicals, and the suspended particles. The suspended particles are commonly silicon dioxide (SiO₂) but can be other materials such as aluminum dioxide (AlO₂) or cerium dioxide (CeO₂).

Some of the substrates that are cleaned or processed in this manner include semiconductor wafers and glass and ceramic substrates, as well as substrates comprised of other materials. For semiconductor wafer cleaning, the process is known as a chemical mechanical polishing (CMP) process. In the CMP process, the abrasive process fluid is pumped from a source to a tool that uses the “slurry” to perform a grinding/polishing/removal process on the semiconductor wafer. The quality of the finished surface can depend on how well the particles stay suspended in the process fluid. A problem that sometimes arises is that the particles attract each other and form large clusters or clumps. These clusters may plug filters in the CMP tool and can cause scratches on the surface being polished if they get through the filters.

To address this clustering (or clumping) problem, the tool 10 is inserted into the CMP tool, preferably as close to the point of use of the slurry as possible. While the process fluid is flowing from the source to the point of use (e.g. the surface of a semiconductor wafer), it flows through the passageway 30 of the tool 10 where the process fluid is exposed to the focused acoustic energy from the transducer 34. By focusing the acoustic energy, a significant amount of energy can be applied to the flowing process fluid, causing cavitation to occur in the process fluid while it passes through the tool 10 thereby breaking up the clusters or clumps of abrasive particles. Cavitation is the creation of bubbles or voids in a liquid created by the cycling pressure from the transducer 34 that sends high frequency oscillating sound waves into the process fluid. When the bubbles or voids collapse, a high amount of energy is released which causes the clusters to break up.

For a representative tool 10 comprised of stainless steel, and used in anti-clumping process, the dimensions shown in FIG. 2 are approximately as follows: L=5.38 inches (137 mm), K=3.38 inches (85.8 mm), “e” is 0.44 inches (11.2 mm), and the length “C” of crystal 18 is approximately 2.50 inches (63.5 mm). The width “D” (i.e., the outer diameter or OD) and the diameter “d” (i.e., the inner diameter or ID) are 1.77 inches (45 mm) and 0.30 inches (7.68 mm), respectively, but other values can be used for all of these dimensions depending on the particular design of the tool 10.

A second use of the tool 10 is for the generation of reactive oxygen species in fluids, such as the process fluid (slurry) used in a chemical mechanical polishing (CMP) process during the manufacturing of semiconductor devices. The generation of reactive oxygen species (ROS) when water-based fluids or chemicals are exposed to acoustic energy has long been known. For example, this phenomenon is discussed in the paper Merouani et al., Sensitivity of Free Radicals Production in Acoustically Driven Bubble to the Ultrasonic Frequency and Nature of Dissolved Gasses, Ultrasonics Sonochemistry, volume 22, pages 41-50, 2015 (available online Jul. 25, 2014). Reactive oxygen species are energetic oxygen containing species that tend to have high chemical reactivity. Examples include hydroxyl radicals (HO·), hydroxide ions (HO⁻), hydrogen peroxide (H₂O₂), peroxide ion (O₂²⁻), singlet oxygen (¹O₂), and superoxide anion (·O₂⁻). The use of acoustic energy and reactive oxygen species to enhance a CMP process has been reported. See, International Publication Number WO/2023/149925 A1, Araca, Inc., Chemical Mechanical Planarization Slurry Processing and Systems and Methods for Polishing Substrate Using the Same, published 10 Aug. 2023.

The in-line focused acoustic energy tool 10 addresses several issues related to the generation and use of ROS in an industrial process such as CMP. First, the efficient generation of ROS using acoustic energy requires that high power levels of acoustic energy are transmitted into the process fluid/slurry. The use of an in-line source of acoustic energy like the tool 10 provides the required high-power levels because the acoustic energy is focused in (or near) the fluid passageway 30 by the cylindrical lens 40.

Second, in general most ROS have a relatively short lifetime. Because of this, the acoustic energy source used to generate the ROS needs to be positioned close to the point of use, such as close to where a substrate is being processed (e.g., close to the semiconductor wafer being processed). The use of the tool 10 addresses this problem because it can be inserted into the process fluid/slurry supply line near the substrate. The small size and light weight of the tool 10 allows it to be positioned as close to the point of use of the slurry as possible, such as on top of the CMP platen where the slurry is dispensed.

Third, the acoustic energy source needs to be capable of generating a variety of powers so as to optimize the generation of the desired ROS. The design of the tool 10 provides this capability because the RF signal applied to the crystal 18 can be varied and the dimensions of the tool 10 can be varied as needed to deliver focused acoustic energy into the fluid passageway 30. A fourth advantage of the tool 10 is that it can be constructed of an inert material, like sapphire, that will not react with the ROS. Additionally, the tool 10 can be enclosed in a high purity housing made from materials that are cleanroom compatible, like PTFE (polytetrafluoroethylene) or PEEK (polyether ether ketone).

In operation as an ROS generator, the tool 10 functions as follows: the tool 10 is inserted into the process fluid supply line of the CMP tool, preferably near the nozzle that dispenses the slurry. While the process fluid is flowing from the source to the point of use (e.g. the surface of a semiconductor wafer), it flows through the passageway 30 of the tool 10 where the process fluid is exposed to the focused acoustic energy from the transducer 34. By focusing the acoustic energy, a significant amount of energy can be applied to the flowing process fluid, causing cavitation to occur in the process fluid while it passes through the passageway 30. Without being bound by theory, it is thought that the energy released during cavitation produces the ROS from some of the chemicals present in the process fluid. Cavitation is the creation of bubbles or voids in a liquid created by the cycling pressure from the transducer 34 that sends high frequency oscillating sound waves into the process fluid. When the bubbles or voids collapse, a high amount of energy is released which causes the ROS to form.

RF power is applied to the crystal 36 which causes acoustic energy to be produced by the transducer 34. Generally, the RF power is supplied to the crystal 36 for 15-60 seconds and then stops, but this can be varied depending on the application. The curved shape of the resonator 14 focuses the acoustic energy in the part of the passageway 30 that extends along the length of the passageway 30 underneath the crystal 18. After an appropriate period of time, depending on the planarization process, the power to the crystal 36 is turned off and the slurry can be rinsed from the surface of the semiconductor wafer or other substrate being processed.

For a representative tool 10 comprised of sapphire and used for the generation of reactive oxygen species in fluids, the dimensions shown in FIGS. 2 and 4 would be approximately as follows: M=5.5 inches (140 mm), K=4.0 inches (101.6 mm), “e” is 0.5 inches (12.7 mm), and the length “C” of crystal 18 is approximately 3.0 inches (76.2 mm). The width “D” (i.e., the outer diameter or OD) and the diameter “d” (i.e., the inner diameter or ID) are 0.71 inches (18 mm) and 0.24 inches (6.10 mm), respectively, but other values can be used for all of these dimensions depending on the particular design of the tool 10. A sapphire tool 10 having these dimensions could be used in an anti-clumping process as well as for as an ROS generator.

FIGS. 1-4 illustrate embodiments of the in-line focused acoustic energy tool 10 that use a crystal 18 that is curved to fit the shape of the cylindrical resonator 34. However, the components of the tool 10 (i.e., the resonator and crystal) can have other shapes that still deliver focused acoustic energy to a fluid stream flowing through the resonator. For example, FIG. 5 illustrates an in-line focused acoustic energy tool 70 that uses a rectangular shaped resonator 74 and one or more flat rectangular shaped crystals 78 instead of the cylindrically shaped resonator 34 and the curved crystal 18 shown in FIG. 1. The resonator 74 has a length “B,” a height “H,” and a width “E” and the tool 70 functions analogously to the tool 10.

In FIG. 5, the crystal 78 comprises two crystal segments 82 and 86. A fluid passageway 90 is positioned inside the resonator 74. The fluid passageway 90 is a hollow cavity that allows process fluid from a fluid source (not shown) to flow through the resonator 74 analogously to the fluid passageway 30. In a preferred embodiment, the fluid passageway has the shape of a right circular cylinder that extends along the length “B” of the resonator 74 and which is centered in the resonator 74, but other shapes can be used. The crystal 78 has a length “S” and the two crystal segments 82 and 86 have lengths “V” and “W,” respectively.

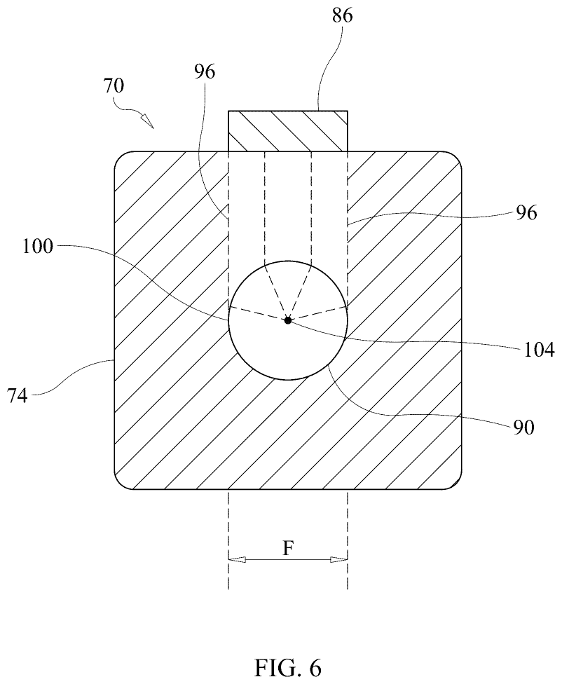

FIG. 6 illustrates a cross section of the tool 70. The dashed lines 96 depict acoustic energy generated by the crystal 86 moving through the resonator 74. A curved boundary 100 is formed in the resonator 74 at the interface of the fluid passageway 90 and the resonator 74. When the acoustic energy reaches the curved boundary 100, the acoustic energy is focused toward the center 104 of the fluid passageway 90. It is thought that this focusing occurs because the speed of sound inside the passageway 90 (or in the fluid that flows in the passageway 90) differs from the speed of sound in the resonator 74.

Since the curved boundary 100 is formed in the resonator 74, the resonator 74 includes a curved surface for focusing the acoustic energy being transmitted through the resonator, namely the curved boundary 100. Because the fluid passageway 90 is a hollow lumen in the resonator 74, it is also true that the curved surface comprises at least part of the perimeter of the fluid passageway 90, namely the curved boundary 100. An alternative statement is that the curved surface comprises at least part of the resonator adjacent to the fluid passageway, namely the curved boundary 100. The fluid passageway 90 has a diameter “F.”

In practice, one reason for using the flat rectangular shaped crystals 78 is that it is easier (faster) and less expensive to obtain rectangular shaped crystals from commercial sources than it is to obtain curved crystals which frequently must be custom manufactured. In the embodiment shown in FIG. 5, the two crystal segments 82 and 86, having the lengths “V” and “W,” respectively are used as the crystal 78 for convenience to get the desired crystal length. A single crystal segment having length “S” could be used, or more than two crystal segments could be used. In a preferred embodiment, the lengths V and W are approximately 2.76 inches (7 cm) and the width of the crystal 78 is approximately 0.55 inches (1.4 cm), but other crystal sizes can be used.

The in-line focused acoustic energy tool 70 that uses the rectangular shaped resonator 74 and one or more flat rectangular shaped crystals 78 can be used for any of the purposes described previously with respect to FIGS. 1-4. Specifically, the tool 70 can be used to minimize clumps from forming in a fluid, such as a process fluid used in a chemical mechanical polishing process during the manufacturing of semiconductor devices. Similarly, the tool 70 can be used to generate reactive oxygen species in a fluid, such as a process fluid used in a chemical mechanical polishing process during the manufacturing of semiconductor devices. Additionally, the resonator 74 can be comprised of many inert materials discussed previously with respect to the resonator 14, such as of sapphire, stainless steel (e.g. 316 stainless steel), silicon carbide, silicon nitride, vitreous carbon, quartz, ceramic materials, and diamond-like carbon (DLC) coated materials can be used. A general consideration for the resonator material is that it is compatible with the fluid being used (i.e., it doesn't react with the fluid). This consideration favors sapphire because of its inertness.

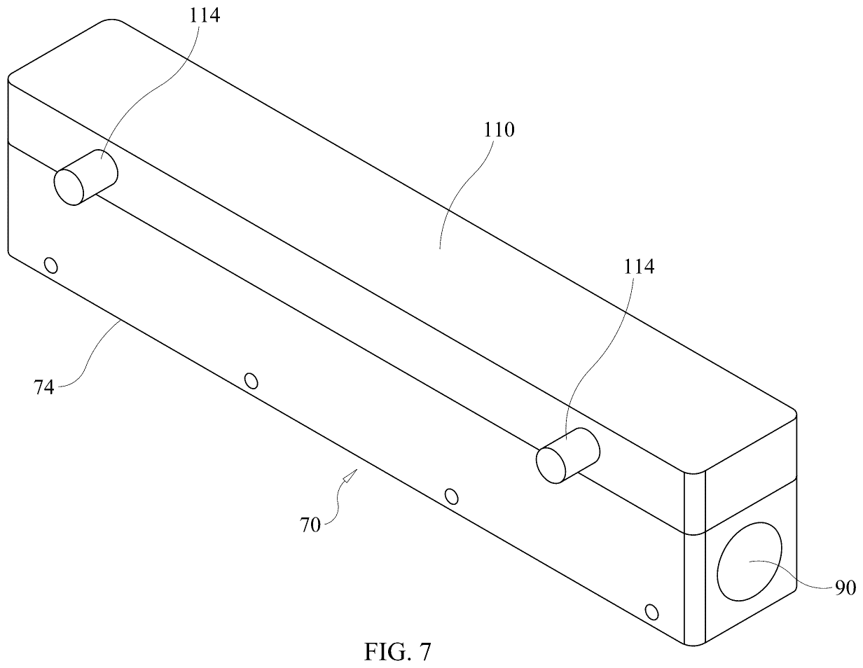

In a preferred embodiment, the tool 70 includes a housing 110 that covers and protects the crystals 78 from damage as is shown in FIG. 7. An electrical connector 114, such as an SMA jack (subminiature version A jack) extends through the housing 110 to allow an electrical connection to be made between an RF generator (not shown) and the crystal 78. Generally, one connector 114 is provided for each of the crystals 78 used in the tool 70. Preferably, the housing 110 forms a liquid tight cover over the crystal 78 and comprises a chemically inert material such as chlorinated polyvinyl chloride (CPVC), but other materials can be used. Preferably, the housing 110 is attached to the resonator 74 using screws, but other attachment means can be used.

Representative dimensions for the tool 70 shown in FIG. 5 (when the resonator 74 comprises stainless steel) are as follows, but these dimensions can be altered depending on the use of the tool 70. B=6.88 inches (17.48 cm); H=0.88 inches (2.24 cm); and E=1.0 inch (2.54 cm). Preferably, the diameter F of the fluid passageway 90 is approximately 0.554 inches (14 mm) and the ends of the passageway 90 are threaded (e.g. ⅜ inch NPT) to allow connection to a fluid source. Preferably, the resonator 74 comprises a chemically inert material such as 316 L stainless steel, but other materials can be used as was noted previously with respect to the resonator 14. Preferably, the crystal 78 is attached to the resonator 74 using an adhesive material such as indium or an epoxy. Preferably, the crystal 78 comprises a PZT type crystal (lead zirconate titanate crystal), such as a man-made crystal that vibrates at a designed frequency. In a preferred embodiment, this frequency is 925 KHZ, but other frequencies can be used, and other piezoelectric materials can be used for the crystal 78.

An RF (Radio Frequency) generator supplies a high frequency alternating current (AC) voltage to the crystal 78 (i.e., to the crystal segments 82 and 86) that causes the crystal to vibrate at the same frequency as the applied AC voltage thus producing the acoustic energy (depicted by dashed lines 96 in FIG. 6). An equivalent explanation is that the RF generator supplies AC power to the crystal 78 because voltage and power are mathematically and physically related. The frequency range of the RF generator is preferably in the range of 300 kHz to 5 MHz, or more preferably in the range of 400 kHZ to 3 MHz. A preferred frequency for use with the tool 70 is 925 kHz, but other frequencies can be used.

In a preferred embodiment, the in-line focused acoustic energy tools 10 and 70 comprise a crystal comprised of a piezoelectric material for generating acoustic energy when a voltage is applied to the crystal, and a resonator comprised of a material that transmits at least some of the acoustic energy generated by the crystal through the resonator. The crystal is attached to the resonator and the tool includes a curved surface for focusing at least some of the acoustic energy being transmitted through the resonator to generate an amount of focused acoustic energy. A fluid passageway extends through the resonator for allowing a fluid to flow through the resonator, with at least some of the focused acoustic energy being directed into the fluid passageway. This focused acoustic energy causes cavitation to occur in at least some of the fluid when the fluid is flowing through the resonator.

In one embodiment of the invention, the curved surface for focusing at least some of the acoustic energy is the curved crystal 18 discussed with respect to FIG. 3. In another embodiment, the curved surface is the curved boundary 100 discussed with respect to FIG. 6. Preferably, the crystal generates acoustic energy in response to a signal from an RF generator, such as an AC voltage or AC power signal. Preferably, the power of the focused acoustic energy in the fluid passageway is greater than the power applied to the crystal to generate the acoustic energy.

In a preferred embodiment, a method for breaking up clumps in a fluid comprises the steps of causing a fluid containing suspended particles to flow through a passageway in a tool, where the suspended particles sometimes form one or more clumps of suspended particles. Focused acoustic energy is delivered into at least part of the passageway while the fluid is flowing through the passageway, with the focused acoustic energy causing cavitation to occur in the fluid, and the cavitation causes at least some of the clumps that have formed in the fluid to break up. Preferably, a piezoelectric crystal is used to generate the acoustic energy and a curved surface in the tool is used to produce the focused acoustic energy.

In a preferred embodiment, a method for generating reactive oxygen species in a fluid comprises the steps of causing a fluid to flow through a passageway in a tool and delivering focused acoustic energy into at least part of the passageway while the fluid is flowing through the passageway. The focused acoustic energy causes cavitation to occur in the fluid which is sufficiently energetic to cause the formation of one or more reactive oxygen species in the fluid. Preferably, a piezoelectric crystal is used to generate the acoustic energy; and a curved surface in the tool produces the focused acoustic energy. In both of these methods, the piezoelectric crystal preferably has either a curved shape, or the crystal has a rectangular shape and the passageway 90 has a cylindrical shape as illustrated in FIGS. 5 and 6.

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true scope of the invention.

We claim:

1. An acoustic energy tool comprising:
a crystal comprised of a piezoelectric material for generating acoustic energy;
a resonator comprised of a material that transmits at least some of the acoustic energy generated by the crystal through the resonator with the crystal being attached to the resonator;
a curved surface for focusing at least some of the acoustic energy being generated by the crystal to generate an amount of focused acoustic energy; and
a fluid passageway extending through the resonator for allowing a fluid to flow through the resonator, with at least some of the focused acoustic energy being directed into the fluid passageway with sufficient power to cause cavitation in the fluid;
wherein the focused acoustic energy causes cavitation to occur in at least some of the fluid when the fluid is flowing through the resonator.

2. The acoustic energy tool of claim 1 wherein the crystal comprises a PZT crystal.

3. The acoustic energy tool of claim 1 wherein the resonator comprises at least one of sapphire, stainless steel, silicon carbide, silicon nitride, vitreous carbon, quartz, ceramic materials, or diamond-like carbon coated materials.

4. The acoustic energy tool of claim 1 wherein the resonator has a cylindrical shape.

5. The acoustic energy tool of claim 4 wherein the crystal has a curved shape to fit on an outside surface of the resonator and the curved surface comprises the curved shape of the crystal.

6. The acoustic energy tool of claim 1 wherein the resonator has a rectangular shape.

7. The acoustic energy tool of claim 1 wherein the crystal comprises one or more rectangular shaped pieces, the fluid passageway has a cylindrical shape, and the curved surface comprises at least part of the resonator adjacent to the fluid passageway.

8. The acoustic energy tool of claim 1 wherein the fluid passageway has a cylindrical shape.

9. The acoustic energy tool of claim 1 wherein the cavitation is sufficient to break up clumps of solid material suspended in the fluid when such clumps are present in the fluid.

10. The acoustic energy tool of claim 1 wherein the cavitation is sufficient to generate reactive oxygen species in the fluid.

11. The acoustic energy tool of claim 1 wherein an AC voltage in the frequency range of 300 kHz to 6 MHz is applied to the crystal to generate the acoustic energy.

12. The acoustic energy tool of claim 11 wherein the frequency is approximately 925 kHz.

13. The acoustic energy tool of claim 1 wherein the power of the focused acoustic energy in the fluid passageway is greater than the power applied to the crystal to generate the acoustic energy.

14. A method for breaking up clumps in a fluid comprising:
causing a fluid containing suspended particles to flow through a passageway in a tool, the suspended particles sometimes forming one or more clumps of suspended particles; and
delivering focused acoustic energy into at least part of the passageway while the fluid is flowing through the passageway, with the focused acoustic energy causing cavitation to occur in the fluid;
wherein the cavitation causes at least some of the clumps that have formed in the fluid to break up.

15. The method of claim 14 further comprising:
using a piezoelectric crystal to generate acoustic energy; and
using a curved surface in the tool to generate the focused acoustic energy.

16. The method of claim 15 wherein the piezoelectric crystal has a curved shape or a rectangular shape.

17. The method of claim 14 wherein the passageway has a cylindrical shape.

18. A method for generating reactive oxygen species in a fluid comprising:
causing a fluid to flow through a passageway in a tube; and
delivering focused acoustic energy into at least part of the passageway while the fluid is flowing through the passageway, with the focused acoustic energy causing cavitation to occur in the fluid;
wherein the focused acoustic energy causes the formation of one or more reactive oxygen species in the fluid.

19. The method of claim 18 further comprising:
using a piezoelectric crystal to generate acoustic energy; and
using a curved surface in the tool to generate the focused acoustic energy.

20. The method of claim 19 wherein the piezoelectric crystal has a curved shape or a rectangular shape and the passageway has a cylindrical shape.
